(19) United States
(12) Patent Application Publication
(10) Pub. No.: US 2014/0313726 A1
(43) Pub. Date: Oct. 23, 2014

(54) LIGHT STRING WITH DIVERSIFIED LIGHTING

(71) Applicant: CHENG-YAO CHIANG, Hsinchu City (TW)

(72) Inventor: CHENG-YAO CHIANG, Hsinchu City (TW)

(21) Appl. No.: 13/867,135

(22) Filed: Apr. 22, 2013

(51) Int. Cl. F21S 4/00

(52) U.S. Cl. CPC F21S 4/002
USPC 362/249.16

(57) ABSTRACT

The present invention provides a light string with diversified lighting, mainly disposing a controller having multiple blink and jump models on a electric wire at power supply leading edge of a light string formed by combining a plurality of lamp strings strung with several lamps together, thereby to allow the lighting of lamps on all lamp strings of the whole light string to change, blink and jump vertically and levelly simultaneously through the controller 20 in operation with the main control IC to achieve a more dazzling and appealing lighting effect.

### TECHNICAL FIELD OF THE INVENTION

The present invention relates to a light string structure used for decoration or in festivals and celebrations, suitable for application to a light string having a plurality of lamp strings such as curtain-typed light string, mesh-typed light string or icicle-typed light string

### DESCRIPTION OF THE PRIOR ART

The light string of the present invention is a light string having a plurality of lamp strings strung together. In a curtain-falling way Such kinds of light strings mostly are curtain light strings, mesh light strings and icicle light strings, and they can have a more dazzling effect than general single-string type light strings when light is on. But, such kinds of light strings are insufficient in controlling the blink and jump function of the whole set of lamps combined together in a curtain-falling form.

### SUMMARY OF THE INVENTION

To improve the deficiencies mentioned above, allow such kind of light string to have a more dazzling, appealing lighting effect of a diversified blink, jump model, the present invention is proposed.

The main object of the present invention is to improve a lighting effect of a light string such as curtain light string, mesh light string or icicle light string, which has a plurality of lamp strings combined together in a curtain-falling form, allowing the whole light string to achieve a more dazzling, appealing lighting effect of a diversified blink, jump model, thereby elevating the practicability thereof.

### BRIEF DESCRIPTION OF THE DRAWINGS

FIG. 1 is a schematic view of a preferred embodiment of a curtain-typed light string according to the present invention; and

FIG. 2 is a schematic view of a preferred embodiment of a mesh-typed light string according to the present invention.

### DETAILED DESCRIPTION OF THE PREFERRED EMBODIMENTS

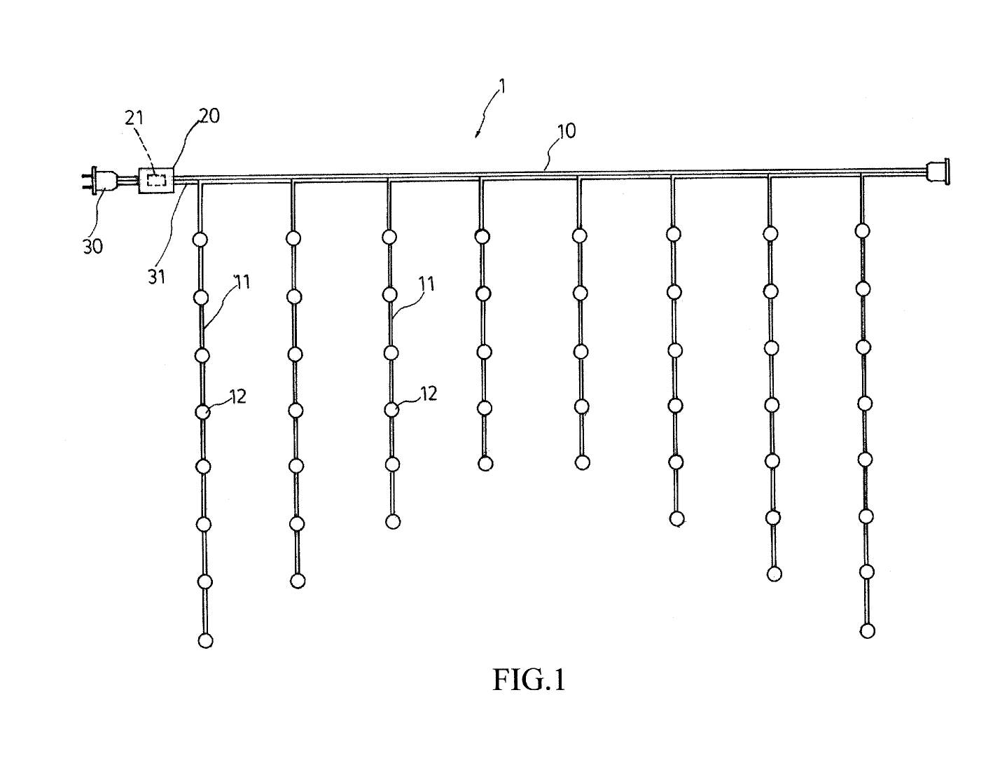

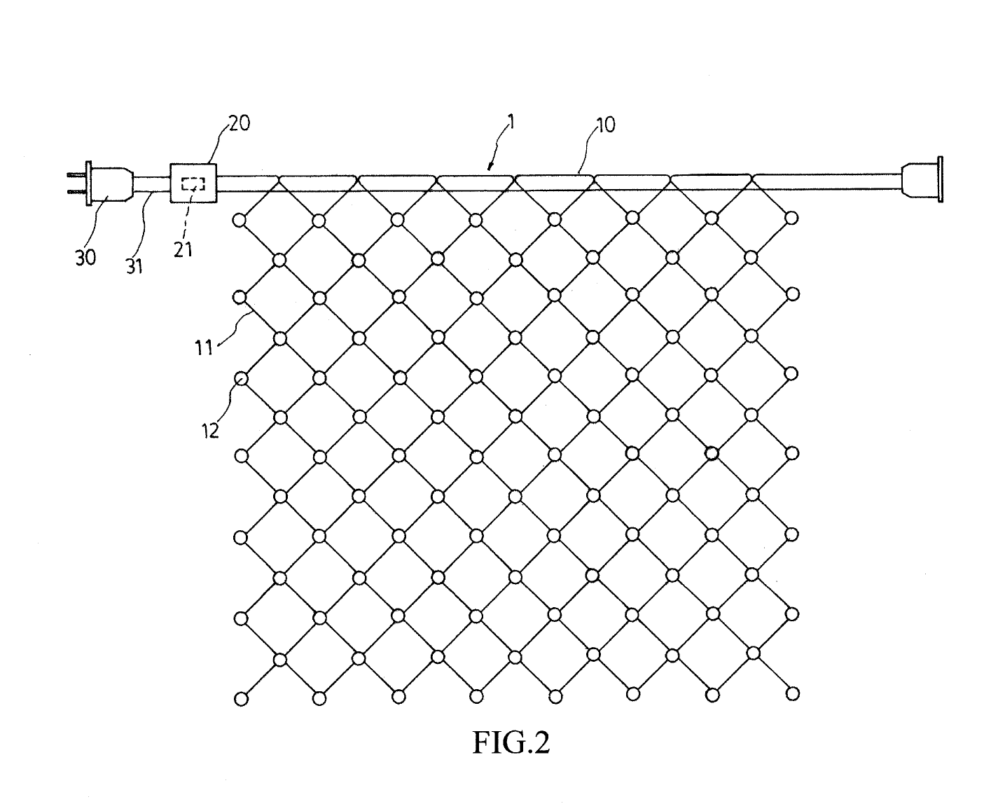

Referring to FIGS. 1 and 2, which respectively show structure configurations of curtain and mesh light strings of preferred embodiments according to the present invention, a light string 1 is disposed with a plug 30 capable of being plugged in a socket connected with a power source. The plug 30 is connected through an electric wire with a light string main body 10 formed by combining a plurality of lamp strings 11 together in a curtain-falling form, where several lamps 12 are disposed on each lamp string 11. The present invention is characterized in that a controller 20 is configured on the electric wire 31 between the light string main body 10 and the plug 30, and a main control IC 21 having multiple blink an jump models is disposed in the controller 20, controlling the lighting emitted from the lamps 12 disposed on all the lamp strings 11 of the whole light string main body 10 to change, blink or jump vertically and levelly simultaneously through the controller 20 in operation with the main control IC, thereby allowing the lighting of the light string to have diversified, and more blinking, dazzling and appealing effects.

I claim:

1. A light string with versified lighting, a plug being disposed on one end of a light string, said plug being connected with a light string main body formed by combining a plurality of lamp strings together in a curtain-falling form through an electric wire, and several lamps being disposed on each said lamp string; wherein a controller is disposed on said electric wire between said light string main body and said plug, and a main control IC having multiple blink and jump models is disposed in said controller, controlling lighting emitted from lamps on all said lamp strings of said light string main body to change, blink or jump vertically and levelly simultaneously.
